(19) United States
(12) Patent Application Publication
(10) Pub. No.: US 2016/0027075 A1
(43) Pub. Date: Jan. 28, 2016

(54) LOGISTICS MANAGEMENT SYSTEM WITH ALL-IN SPOT RATE PRICING

(71) Applicants: Susan M. Dohm, Apex, NC (US); William A. Loebertmann, Eagan, MN (US); Stepanie Kirkham, Quebec City (CA); Kenneth L. Hoffman, Eagan, MN (US)

(72) Inventors: Susan M. Dohm, Apex, NC (US); William A. Loebertmann, Eagan, MN (US); Stepanie Kirkham, Quebec City (CA); Kenneth L. Hoffman, Eagan, MN (US)

(73) Assignee: Unisys Corporation, Blue Bell, PA (US)

(21) Appl. No.: 14/338,456

(22) Filed: Jul. 23, 2014

(51) Int. Cl. G06Q 30/04

(52) U.S. Cl. CPC G06Q 30/04

(57) ABSTRACT

Systems and methods for performing all-in spot rate pricing with a logistics management system are provided. Embodiments may include receiving, via an interface that includes spot rate information, an instruction to produce a spot rate for an air waybill that includes a transportation charge and a plurality of other charges. Embodiments may also include calculating the spot rate that includes the transportation charge and the plurality of other charges to obtain a calculated all-in spot rate. Some embodiments may further include outputting an air waybill that is generated to include at least the calculated all-in spot rate.

### FIELD OF DISCLOSURE

The instant disclosure relates to logistics management systems (LMSs). More specifically, this disclosure relates to all-in spot rate pricing for air waybills (AWBs) in LMSs.

### BACKGROUND

One application of logistics management is the management of freight shipments. This process can be complex, and often requires coordination of multiple participants, including freight forwards, carriers, and the like. In addition, the process often requires some form of shipment tracking, capacity control of flights, container control, terminal management, cash management, consolidation, and other common freight management tasks.

To assist with this complex process, LMSs have been developed. These systems typically provide computing resources to process freight shipment data, and attempt to aid in scheduling, coordinating and tracking various aspects of the freight shipment. These systems typically require significant data entry, based on current shipping volumes and the number of participants, customers, agents, and other resources that may be associated with the shipments. Because of the complexity of the system and the resources associated with shipments, tasks performed and documents generated by individuals using conventional LMSs are prone to error, thereby requiring corrections that impact the normal flow of business. For example, one document that may be generated by or on behalf of a shipper using an LMS is an AWB. Typically, an AWB is a document that evidences the contract between the shipper and the carrier(s) for carriage of goods over routes of the carrier(s). For example, an AWB may specify a spot rate for transportation of the carriage and may specify a separate list of other charges associated with the transportation of the carriage. However, because of the complexity of the system and the resources associated with shipments, incorrect spot rate pricing may occur. As a result, numerous AWB adjustments are often necessary.

### SUMMARY

The number of AWB adjustments that result from incorrect spot rate pricing may be reduced by implementing an all-in spot rate pricing feature in LMSs that provides a single spot rate for an AWB that includes a transportation charge and a plurality of other charges. By incorporating into the spot rate the transportation charge and other user-specified charges, the total number of charges not included in the spot rate may be reduced. Consequently, the number of charges that may change, and possibly require an AWB adjustment, after a spot rate is quoted for an AWB may be reduced.

According to one embodiment, a method may include receiving, with a processor, via an interface that includes spot rate information, an instruction to produce a spot rate for an air waybill that includes a transportation charge and a plurality of other charges. The method may further include calculating, with the processor, the spot rate that includes the transportation charge and the plurality of other charges to obtain a calculated all-in spot rate. The method may also include outputting, with the processor, an air waybill that is generated to include at least the calculated all-in spot rate.

According to another embodiment, a computer program product may include a non-transitory computer-readable medium comprising code to perform the step of receiving, via an interface that includes spot rate information, an instruction to produce a spot rate for an air waybill that includes a transportation charge and a plurality of other charges. The medium may also include code to perform the step of calculating the spot rate that includes the transportation charge and the plurality of other charges to obtain a calculated all-in spot rate. The medium may further include code to perform the step of outputting an air waybill that is generated to include at least the calculated all-in spot rate.

According to yet another embodiment, an apparatus may include a memory, and a processor coupled to the memory. The processor may be configured to execute the step of receiving, via an interface that includes spot rate information, an instruction to produce a spot rate for an air waybill that includes a transportation charge and a plurality of other charges. The processor may also be configured to execute the step of calculating the spot rate that includes the transportation charge and the plurality of other charges to obtain a calculated all-in spot rate. The processor may be further configured to perform the step of outputting an air waybill that is generated to include at least the calculated all-in spot rate.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a block diagram illustrating a network-based environment for managing and tracking shipments according to one embodiment of the disclosure.

FIG. 2 is a block diagram illustrating a logistics management system according to one embodiment of the disclosure.

FIG. 3A is a screen shot illustrating a task-oriented user interface presented by the logistics management system according to one embodiment of the disclosure.

FIG. 3B is a screen shot illustrating a task-oriented shortcut menu displayed by the user interface according to one embodiment of the disclosure.

FIG. 4 is a flow chart illustrating a method for all-in spot rate pricing with a logistics management system according to one embodiment of the disclosure.

FIG. 5 is a screen shot illustrating a user interface for initiating all-in spot rate pricing with a logistics management system according to one embodiment of the disclosure.

### DETAILED DESCRIPTION

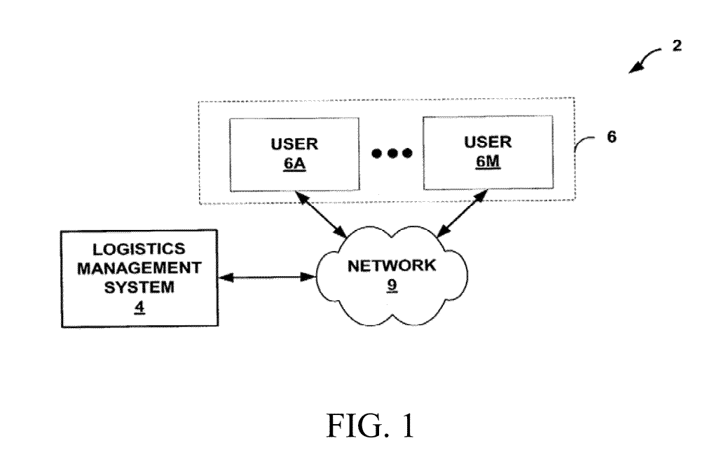

FIG. 1 is a block diagram illustrating an exemplary network-based environment 2 in which logistics management system 4 provides network-based management of freight shipments. Similar logistics management systems include the logistics management systems described in U.S. Pat. No. 7,030,779, U.S. Pat. No. 7,194,695, U.S. Pat. No. 7,278,113, U.S. Pat. No. 7,337,411, U.S. Pat. No. 7,376,571, and U.S. Pat. No. 7,480,867, each of which is incorporated by reference herein. As described in detail FIG. 1, logistics management system 4 provides a task-oriented user interface with which authorized users 6A-6M (collectively “users 6”) of an airline interact with the system to perform a wide range of tasks associated with shipment management. A user may be, for example, a station manager, office personnel, warehouse staff, space control staff, and the like. Exemplary tasks include capture of shipment data, tracking and tracing shipments, capacity control, container control, terminal management, cash management, consolidation, and other common freight tasks.

Logistics management system 4 presents the user interface as a graphical set of interrelated screens. Regardless of the selected task, logistics management system 4 presents the user interface in a consistent manner that may allow the user to perform the task by interacting with a single input screen. Specifically, logistics management system 4 presents each screen to include an item selection region, one or more activity regions, and an action region.

In general, the item selection region allows the user to identify one or more “items,” e.g., a cargo item, a person, an event, a flight, or the like. The activity regions of the screen allow the user to provide input data for a defined set of activities or steps associated with the task, i.e., activities necessary for completion of the overall task. The action region allows the user to perform one or more actions on the item specified with item selection region based on the data specified within activity regions, thereby completing an overall shipment management task with a single action. In this manner, the user need not interact with multiple screens to complete the various activities associated with an overall task.

The task-oriented nature of the interface provided by logistics management system 4 facilitates ease of use by the users, even by relatively untrained individuals. As a result, logistics management system 4 may achieve a reduction in human-related errors, as well reduced training costs. Moreover, by allowing the user to initiate multiple cargo management activities with a single entry, the system may achieve increased employee productivity.

Each user typically accesses logistics management system 4 via, network 9 using a remote computing device having suitable communication software, e.g., a web browser. A user may access logistics management system 4 using a network-enabled computing device, such as a workstation, personal computer, laptop computer, or a personal digital assistant (PDA). The communication device executes communication software, such as a web browser, in order to communicate with logistics management system 4.

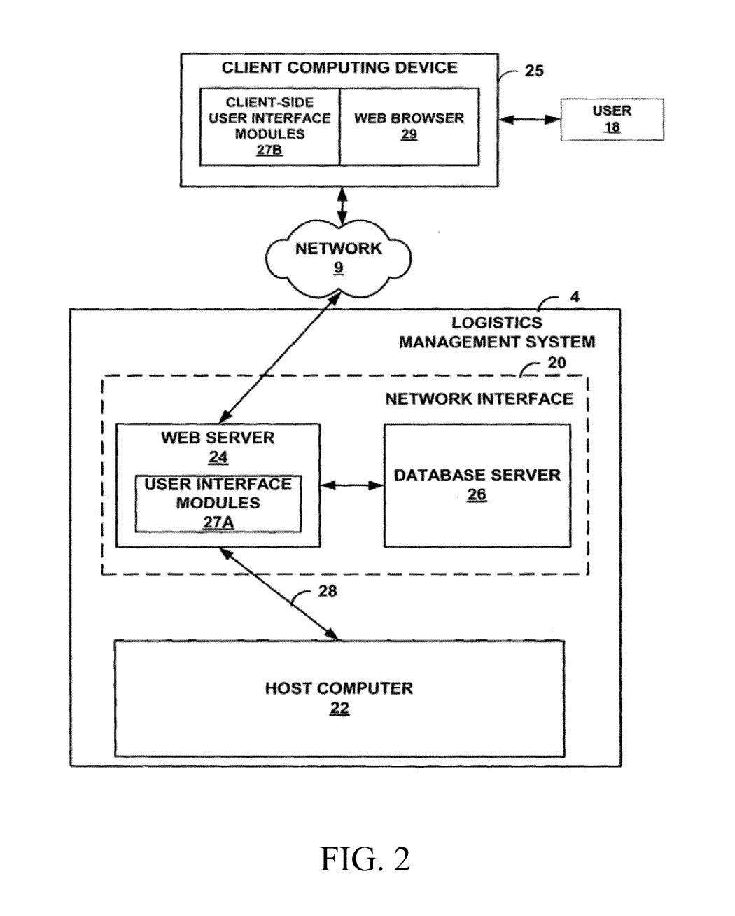

FIG. 2 is a block diagram illustrating an exemplary embodiment of logistics management system 4 in further detail, In the exemplary embodiment, logistics management system 4 includes a host computer 22 coupled to network 9 via network interface 20. In general, host computer 22 provides a computing platform for hosting shipment management services for logistics service providers. Host computer system 22 may comprise, for example, a Unisys 2200 series mainframe executing logistics management software.

Network interface 20 comprises one or more computing devices, e.g., web server 24 and database server 26, that cooperate to provide a seamless, network-based interface by which remote user 18 access host computer 22. Although host computer 22, web server 24, and database server 26 are illustrated separately in FIG. 2 for exemplary purposes, logistics management system 4 may be realized by a single computing device or a plurality of cooperating computing devices.

Web server 24 provides a web-based interface by which an authorized user 18 communicates with logistics management system 4 via network 9. In one configuration, web server 24 executes web server software. As such, web server 24 provides an environment for interacting with remote user 18 via user interface modules 27A, 27B (collectively “user interface modules 27”). As described in detail below, user interface modules 27 provide a task-oriented interface with which user 18 interacts to perform a wide-range of tasks associated with shipment management. User interface modules 27 may include Active Server Pages, web pages written in hypertext markup language (HTML) or dynamic HTML, Active X modules, Java scripts, Java Applets, Distributed Component Object Modules (DCOM), and the like.

Moreover, user interface modules 27 may comprise “server side” user interface modules 27A that execute within an operating environment provided by web server 24, “client-side” user interface modules 27B that are downloaded to and executed on a client computing device 25 of remote user 18, or combinations thereof. Client-side user interface modules 27B could, for example, include Active X components or Java scripts executed by web browser 29 executing on client computing device 25.

User interface modules 27 interact with data base server 26 to retrieve user-specific information. For example, user 18 may interact with logistics management system 4 to define a variety of preferences for controlling operation of user interface modules 27. Database server 26 may provide an operating environment for a database management system (DBMS) for storing the user-defined preferences. The database management systems may be a relational (RDBMS), hierarchical (HDBMS), multidimensional (MDBMS), object oriented (ODBMS or OODBMS) or object relational (ORDBMS) database management system.

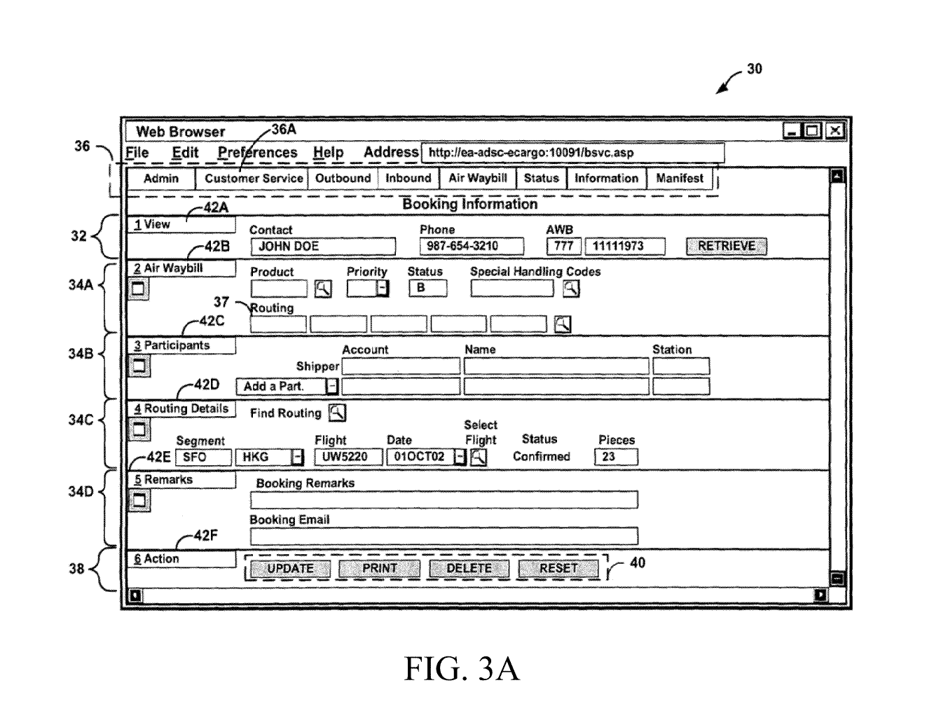

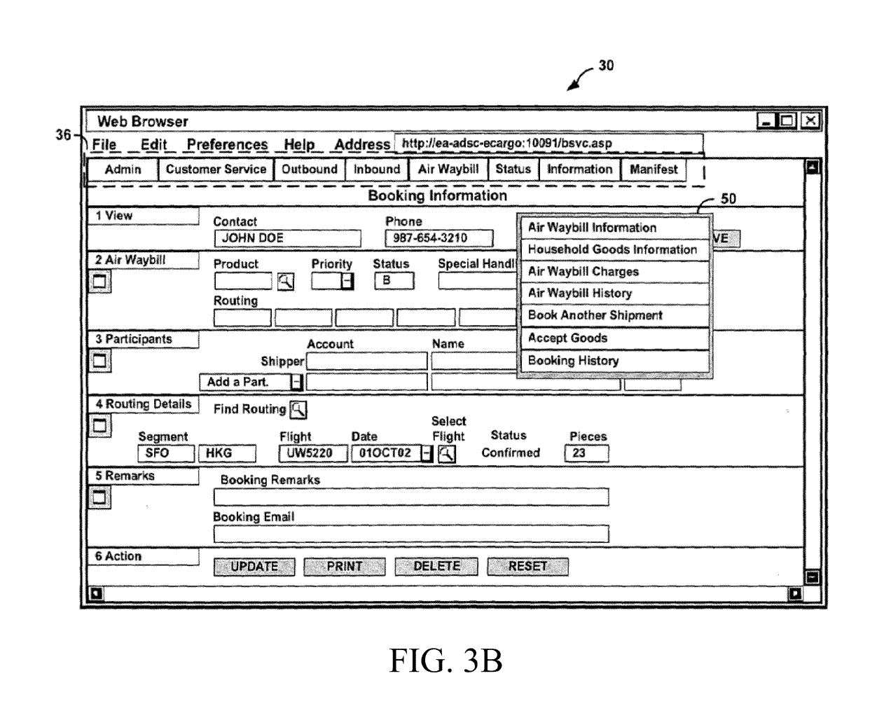

FIG. 3A illustrates an exemplary user interface 30 presented by user interface modules 27 for scheduling and tracking shipments. In the illustrated embodiment, user interface 30 provides menu selection buttons 36 for navigating through a variety of shipment management tasks, e.g., administrative functions, customer service functions, management of outbound freight, management of inbound freight, collecting and maintaining air waybill (AWB) charge information, tracking the status of shipments, and the like. Each menu selection button 36 provides a dropdown menu listing one or more tasks. For example, menu selection button 36A provides a selectable list of tasks relating to maintaining bookings and allotments, finding flight information, providing rate and quote information, providing flight reservations, and the like.

Regardless of the function selected by user 18, user interface modules 27 present user interface 30 in a consistent, task-oriented manner. In particular, as with other input screens presented by user interface modules 27, user interface 30 is divided into at least three regions. An item selection region 32 allows the user to provide an identifier or other information describing one or more “items,” e.g., a cargo item, a person, an event, a flight, or the like. For example, in the exemplary user interface 30 of FIG. 3A, item selection region 32 includes input areas for specifying a contact for an air waybill (AWB). Upon receiving input from user 18 via item selection region 32, web server 24 accesses host computer 22 to retrieve data associated with the specified item.

User interface 30 further includes one or more activity regions 34 for performing a defined set of activities or steps associated with a common task. In particular, user interface 30 presents activity regions 34 within a single window to allow user 18 to perform a complete task for the item specified within item selection region 32. In this example, user interface 30 includes activity regions 34A-34D to capture activity data for performing an overall task associated cargo booking, e.g., creation, modification or deletion of booking activities for the identified item.

More specifically, activity regions 34A-34D present separate input regions that enable user 18 to complete all activities associated with booking a cargo item. Activity region 34A provides input areas with which user 18 interacts to specify an AWB, including a product, priority, status, handling codes, and a complete routing summary 37 that sequentially lists the origin, intermediate, and final destinations of the booked item. Activity region 34B provides input areas by which the user 18 specifies “participants” for the hooking, e.g., a shipper, a consignee, an agent, and the like. Activity region 34C provides input regions by which user 18 specifies individual segments for carrier routes to transport the item. Activity region 34D provides input areas by which user 18 specifies general remarks for the booking.

In this manner, user 18 need not interact with multiple screens to complete the booking. Moreover, activity regions 34A-34 may be hierarchically arranged from top to bottom of user interface 30 based on the order in which a user must complete the activities, thus increasing the intuitive nature of user interface 30. For example, user interface 30 may require that user 18 provide routing information 37 prior to allowing the user to select participants via activity region 34B. Similarly, user interface 30 may require that user 18 select participants via activity region 34B prior to allowing the user to specify segment details via activity region 34C.

Finally, user interface 30 includes an action region 38 to perform one or more actions on the item specified with item selection region 32 based on the data specified within activity regions 34. In this example, action region 38 includes selectable buttons 40 that allow user 18 to update, delete, reset and print the selected item.

To further aid in the intuitive, task-oriented nature of user interface 30, user interface modules 27 include respective headers 42A-42F within each of the input regions 32, 34, 36, and may color-code the headers. For example, header 42A of input selection region 34 and header 42F may be presented in a first color. Headers 42B-42E of activity regions 34 may be presented in a second color. Moreover, each header 42 of user interface 30 may be presented in similar manner regardless of the particular screen being displayed, i.e., the function selected via menus 36.

In addition, user interface 30 makes use of dynamic, task-oriented shortcut menus to aid user 18. More specifically, user 18 may select, e.g., via a “right mouse click,” any of regions 32, 34 and 38 to request a shortcut menu to other related tasks. In response, user interface 30 presents a context-sensitive, task-oriented shortcut menu.

FIG. 3B illustrates an exemplary shortcut menu 50 displayed by user interface 30. In this example, user interface 30 presents shortcut menu 50 to include direct links to other tasks provided by logistics management system 4 that are related to the current task being performed via, user interface 30. For example, because user interface 30 includes activity regions 34 that relate to the task of booking an item, shortcut menu 50 includes links to other related tasks, e.g., accept goods, view booking history, view all AWB information, view goods information, view AWB charges, view AWB history, and book another shipment. When user 18 is viewing an existing booking, he or she may want to view the booking history, view all the charges associated with the shipment, or accept the goods at a warehouse. Although user 18 may navigate to these tasks via menu selection buttons 36, use of shortcut menu 50 avoids any requirement that the user be familiar with the location of the screens in the menu bar structure and the overall task flow. By making use of shortcut menu 50, user interface modules 27 are able to guide user 18 through a flow of tasks, and allow the user to navigate between screens in a task-oriented manner without requiring the user to have detailed knowledge of menus 36.

Moreover, after activating a shortcut menu to another task, user interface modules 27 pre-fill data values of input areas for the new task according to the screen from which the shortcut menu was launched, e.g., user interface 30. More specifically, data provided in item selection region 32 may be used to automatically populate the item selection region for the subsequent task window. Similarly, data from activity regions 34 may be used to populate activity regions for the subsequent task window. During this process, user interface modules 27 may process data from activity regions 34 to compute or otherwise determine the data for the subsequent activity regions.

Another manner in which user interface modules 27 generate user interface 30 to provide a task-oriented interface is via intelligent cursor control. In response to a tab key input, user interface 30 moves between input areas, but controls the cursor to flow through regions 32, 34, 26 in a manner that corresponds to the logical progression of the activities associated with the task. For example, in some cases the flow of a particular task may dictate that a first field appearing lower on user interface 30 be supplied with data before another field appearing above the first field. In this situation, user 18 can employ the tab key to automatically move to the lower first field prior to the other field, without having to remember the order in which the activities of the task should be completed.

In addition, this functionality can be used to aid user 18 when a shortcut menu, e.g., shortcut menu 50, is employed. In particular, in response to the right click or the context menu key input, user interface modules 27 control the navigation through the fields of a subsequent screen based on the shortcut menu that is used to navigate to the screen. For example, assuming user 18 selects “AWB Charges” from shortcut menu 50, user modules 27 will display a subsequent user interface, and control the navigation through the input areas of the subsequent user interface, based on the fact that the user reached the current interface via a shortcut menu from user interface 30, i.e., the Booking Information interface. That is, user interface modules 27 will control the navigation through the AWB Charges interface based on the fact that a booking-type task is underway or was recently performed by user 18.

in this manner, logistics management system 4 provides a task-based interface that helps guide user 18 through a particular task. These techniques allow a user to easily navigate within a particular screen, e.g., web page, and to screens of related tasks.

In view of exemplary systems described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required. to implement methodologies described herein. It is to be appreciated that functionality associated with blocks may be implemented by software, hardware, a combination thereof or any other suitable means (e.g. device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

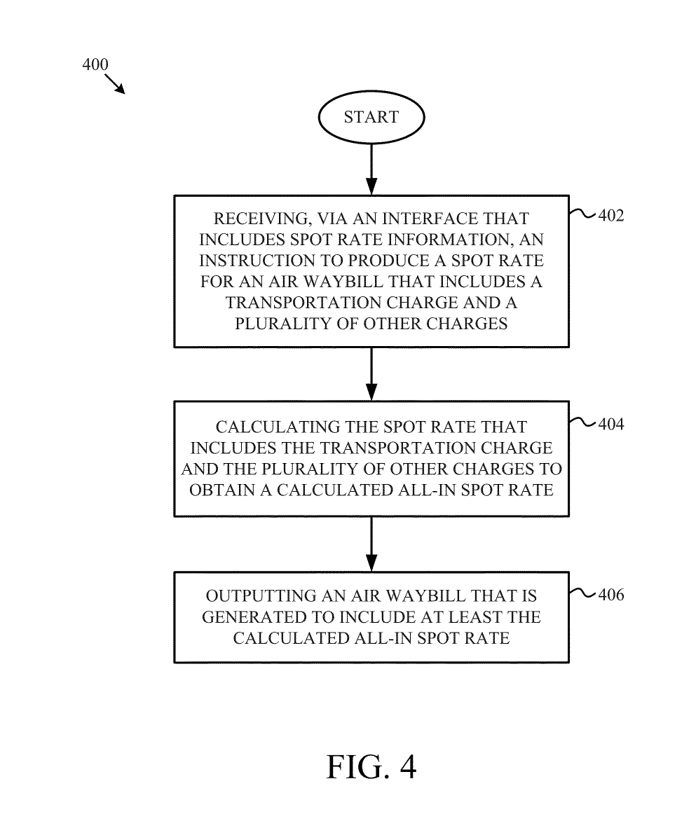

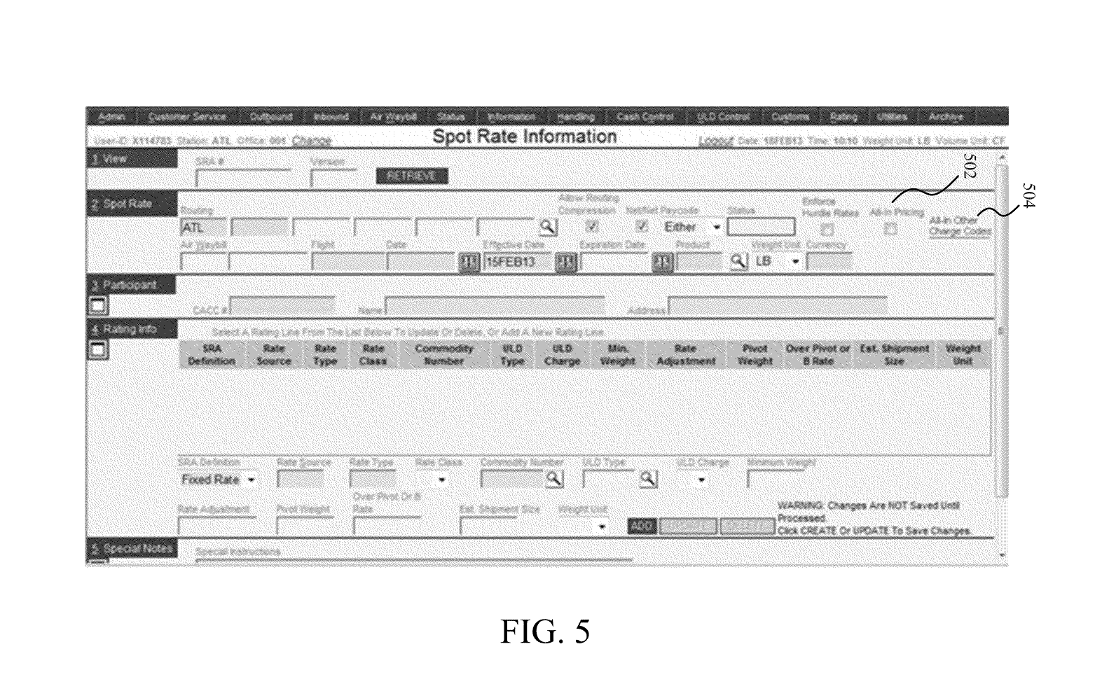

FIG. 4 is a flow chart illustrating a method for all-in spot rate pricing with a logistics management system, such as the logistics management systems described with reference to FIGS. 1-3. A method 400 begins at block 402 with receiving, via an interface that includes spot rate information, an instruction to produce a spot rate for an air waybill that includes a transportation charge and a plurality of other charges. According to an embodiment, transmission of the instruction to a processor instructing the processor to produce the spot rate may be initiated with user input provided on the user interface. For example, FIG. 5 provides a screen shot illustrating a user interface for initiating all-in spot rate pricing with a logistics management system. In addition to including most of the features described with reference to FIGS. 3A and 313, the user interface of FIG. 5 includes additional features and information related to spot rates, such as additional buttons, checkboxes, links, and input text boxes. The additional features and information related to spot rates may allow a user to indicate whether a spot rate to be produced for an air waybill should include other charges, and to specify the other charges that should be included in a calculated spot rate for an air waybill. For example, a user may indicate that a spot rate to be calculated should include a plurality of other charges by checking the “All-in Pricing” checkbox 502. If the user does not check the “All-in Pricing” checkbox 502, then a subsequent spot rate for an air waybill may be calculated without the inclusion of the plurality of other charges.

Referring back to FIG. 4, at block 404, method 400 includes calculating the spot rate that includes the transportation charge and the plurality of other charges to obtain a calculated all-in spot rate. In some embodiments, the plurality of other charges to include in the calculation of the all-in spot rate may be specified by a user. For example, referring to FIG. 5, a user may click the “All-in Other Charge Codes” link 504 to open a window that allows a user to specify what other charges should be included in a calculated spot rate price. Therefore, using the “All-in Other Charge Codes” link 504, a user is able to provide input specifying the plurality of other charges to include in the calculation of the all-in spot rate. Accordingly, when the “All-in Pricing” checkbox 502 is checked, a subsequently calculated spot rate may include each of the other charges specified by a user via the “All-in Other Charge Codes” link 504. According to one embodiment, the plurality of other charges may include at least a fuel charge, a security charge, a delivery charge, a navigation charge, and other surcharges. In some embodiments, the plurality of other charges included in the spot rate calculation may be stored, such as, for example, in a memory.

Referring back to FIG. 4, at block 406, method 400 may include outputting an air waybill that is generated to include at least the calculated all-in spot rate, in addition, a history log of generated air waybills may be updated to indicate the plurality of other charges used to calculate the all-in spot rate that is included in the generated air waybill.

According to an embodiment, when a user indicates that other charges should be included in the calculation of a spot rate to obtain an all-in spot rate, a separate calculation of a charge included in the all-in spot rate is not performed. For example, when a user indicates that a fuel surcharge should be included in the calculation of an all-in spot rate, a separate calculation to determine an individual charge for fuel is not performed. In other embodiments, the separate calculation of a charge included in the all-in spot rate may be set to return a default value of zero.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media,

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for all-in spot rate pricing, comprising:
receiving, with a processor, via an interface that includes spot rate information, an instruction to produce a spot rate for an air waybill that includes a transportation charge and at least one other charge;
calculating, with the processor, the spot rate that includes the transportation charge and the at least one other charge to obtain a calculated all-in spot rate; and
outputting, with the processor, an air waybill that is generated to include at least the calculated all-in spot rate.

2. The method of claim 1, wherein the at least one other charge is specified by a user.

3. The method of claim 1, wherein the at least one other charges comprises at least one of:
a fuel charge;
a security charge;
a delivery charge; and
a navigation charge.

4. The method of claim 1, further comprising storing the at least one other charge included in the spot rate calculation.

5. The method of claim 1, further comprising receiving, via the interface that includes spot rate information, user input specifying the at least one other charge to include in the calculation of the all-in spot rate.

6. The method of claim 1, further comprising updating a history log of generated air waybills to indicate the at least one other charge used to calculate the all-in spot rate that is included in the generated air waybill.

7. A computer program product, comprising:
a non-transitory computer-readable medium comprising code to perform the steps of:
receiving, via an interface that includes spot rate information, an instruction to produce a spot rate for an air waybill that includes a transportation charge and at least one other charge;
calculating the spot rate that includes the transportation charge and the at least one other charge to obtain a calculated all-in spot rate; and
outputting an air waybill that is generated to include at least the calculated all-in spot rate.

8. The computer program product of claim 7, wherein the at least one other charge is specified by a user.

9. The computer program product of claim 7, wherein the at least one other charge comprises at least one of:
a fuel charge;
a security charge;
a delivery charge; and
a navigation charge.

10. The computer program product of claim 7, wherein the medium further comprises code to perform the step of storing the at least one other charge included in the spot rate calculation.

11. The computer program product of claim 7, wherein the medium further comprises code to perform the step of receiving, via the interface that includes spot rate information, user input specifying the at least one other charge to include in the calculation of the all-in spot rate.

12. The computer program product of claim 7, wherein the medium further comprises code to perform the step of updating a history log of generated air waybills to indicate the plurality of other charges used to calculate the all-in spot rate that is included in the generated air waybill.

13. An apparatus, comprising:
a memory; and
a processor coupled to the memory, the processor configured to execute the steps of:
receiving, via an interface that includes spot rate information, an instruction to produce a spot rate for an air waybill that includes a transportation charge and at least one other charge;
calculating the spot rate that includes the transportation charge and the at least one other charge to obtain a calculated all-in spot rate; and
outputting an air waybill that is generated to include at least the calculated all-in spot rate.

14. The apparatus of claim 13, wherein the at least one other charge to include in the calculation of the all-in spot rate are specified by a user.

15. The apparatus of claim 13, wherein the at least one other charge comprise at least one of:
a fuel charge;
a security charge;
a delivery charge; and
a navigation charge.

16. The apparatus of claim 13, wherein the processor is further configured to perform the step of storing the at least one other charge included in the spot rate calculation.

17. The apparatus of claim 13, wherein the processor is further configured to perform the step of receiving, via the interface that includes spot rate information, user input specifying the at least one other charge to include in the calculation of the all-in spot rate.

18. The apparatus of claim 13, wherein the processor is further configured to perform the step of updating a history log of generated air waybills to indicate the at least one other charge used to calculate the all-in spot rate that is included in the generated air waybill.
